(19) United States
(12) Patent Application Publication
(10) Pub. No.: US 2006/0037481 A1
(43) Pub. Date: Feb. 23, 2006

(54) Espresso machine and method of use thereof

(76) Inventor: John Bicht, Loveland, CO (US)

Correspondence Address: SWANSON & BRATSCHUN L.L.C., 1745 SHEA CENTER DRIVE, SUITE 330, HIGHLANDS RANCH, CO, 80129, US

(21) Appl. No.: 11/206,417

(22) Filed: Aug. 18, 2005

Related U.S. Application Data
(60) Provisional application No. 60/602,529, filed on Aug. 18, 2004.

(51) Int. Cl. A47J 31/44

(52) U.S. Cl. 99/279

(57) ABSTRACT

An espresso machine having a brew water tank and a heating block located within the brew water tank. The heating block is preferably made of a thermally conductive material such as copper and will preferably have a body and thermally conductive vertical members extending vertically from the body within the brew water tank. The heating block will be associated with a heat source which can be an electric heater. The espresso machine may also include a pump head consisting of an input, and output, and an impeller mechanism, positioned within the brew water tank and in contact on at least one side with heated brew water. In addition, the brew water conduit connecting the pump to the brew head will be located substantially within the brew water tank. Thus, temperature loss in the brew water conduit or in the pump head will be minimized. In addition, a second heat source may be operatively associated with the bayonet or portafilter. Thus, a reduction in the temperature of brew water as it passes through the ground coffee in the portafilter can be minimized. A separate and distinct exhaust conduit may also be placed in fluid communication with the brew head, allowing the exhaustion of pressurized water from the brew head, after the preparation of a shot of espresso, entirely through a conduit which is separate from the clean water supply.

### RELATED APPLICATION DATA

This application claims benefit of U.S. Provisional Patent Application Ser. No. 60/602,529, filed Aug. 18, 2004, entitled ESPRESSO MACHINE AND METHOD OF USE THEREOF, which application is incorporated herein by reference in its entirety.

### TECHNICAL FIELD

The present invention is directed toward an espresso machine and a method of the use thereof, and more particularly toward an espresso machine featuring precise brew controls.

### BACKGROUND ART

An espresso is a small, concentrated coffee beverage of 2.5 ounces or less for a double espresso, served in a demitasse cup. Espresso has both a liquid and a foam element (crema). Espresso is made on a specialized machine that forces hot water at high pressure through finely ground coffee that has been compacted (tamped) in a filter basket. The force of the pressurized water is spent in the coffee cake during the brew process. It takes roughly 30 seconds to percolate water through the coffee cake (also known as a “puck”). The filter basket is traditionally held in an easily engaged and easily removed portafilter.

Espresso is a very complex beverage with hundreds of unstable organic compounds, all affecting the flavor and experience of the drink. The idea of espresso is to essentially concentrate the essence of the coffee. This is challenging with present equipment. Pressure and brew time control are critical to create well made espresso. Failure to precisely control one or more of these parameters will result in an unsatisfactory espresso.

Over the years, espresso machine technology has improved, resulting in more consistent espresso creation. In 1901, an Italian named Luigi Bezzera invented a machine that employed steam pressure to force water through coffee grounds held in clampable filters. The basic Bezzera design can still be found in use today, although steam pressure is generally too low at only 1.5-2.0 atmospheres to satisfy current standards for the ideal espresso method. However, the Bezzera elements of a clamp, now commonly known as a bayonet, releasably holding a portafilter which contains a puck of tamped, finely ground coffee are present in virtually all modern espresso machines.

The original Bezzera machine was heated over an open flame and suffered the problems of inadequate temperature and pressure controls. Since the time of its invention, the espresso machine has been improved by incorporating electric heating elements. In addition, steam pressure was initially enhanced by hand pull piston machines, and then machines based upon electric pump designs. Prior art espresso machines typically control brew temperature indirectly by controlling the temperature of the water in the brew tank. Generally, water temperature is controlled to a precision of plus or minus 5 or more ° F. Often, the temperature is controlled to a set point and monitored by a mechanical thermostat in the brew tank. The final temperature of the brew water when it reaches the ground coffee in the brew head will vary depending on the distance from the temperature control point and the details of the construction of a particular espresso machine. Temperature drop or rise can occur in the piping or conduits between the brew water tank and the brew head or in the pump head. A particularly dramatic reduction in water temperature can occur in the portafilter which may be 30° F. or more cooler than the desired brew water temperature. In addition, a typical prior art espresso machine will exhibit considerable temperature stratification within the water in the brew water tank. A significant temperature variation from the top to the bottom of a brew water tank can make stable brew temperatures impractical.

The pressure developed at the brew head in a conventional prior art espresso machine is essentially unregulated. Typically, the electric pressurizing pump is run at a single speed which is chosen to approximate the desired brewing pressure. Thus, modern, electric pump based machines lack an element of feedback and control which was present in the hand piston operated machines of the mid 20th century. The hand piston machines, of course, required a great deal of skill to properly operate.

After a shot of espresso is prepared, the remaining pressurized water above the coffee is flushed out of the system and the portafilter is removed and cleaned. Residual coffee in the portafilter, filter basket or diffuser screen, and anywhere else in the brew system will turn rancid quickly and taint every subsequent espresso made. Typical prior art espresso machines utilize an external three way valve in the brew water conduit between the brew water tank to the brew head. This valve either directs brew water from the heated water tank to the portafilter or at an alternative valve setting closes off the brew water tank, but allows residual, pressurized brew water left in the portafilter after extraction to exhaust into the drain. Exhausting is necessary to allow the safe opening of the portafilter and subsequent removal of the remnants of a previous brew. The prior art exhausting procedure causes residual coffee oils and other residues to coat the inside of the brew water supply conduit from the brew head back to the three way valve. Thus, when the next brew is initiated, the incoming clean water must first pass through residue which may have become rancid.

Espresso extraction typically takes place at 8-10 atmospheres of pressure (116-145 psi). This pressure is substantial, and if applied too quickly to the compressed coffee in the portafilter, will cause the compressed coffee puck to break up. This, in turn, would allow the brew water to pass freely through the puck, making extraction only very partially successful. For successful extraction, the coffee in the filter basket must swell and become firm prior to the application of a brew pressure. The original espresso machines relied upon the user to gradually introduce water into the extraction chamber in a process known as “pre-infuse”. The pre-infuse process relied solely upon the skill of the user to achieve brewing pressure without compromising the integrity of the puck. Modern prior art machines often rely solely on a small hole restrictor in the water pipe to reduce the inrush of water, thus simulating a pre-infuse stage.

The present invention is directed toward overcoming one or more of the problems discussed above.

### SUMMARY OF THE INVENTION

One aspect of the present invention is an espresso machine having a brew water tank and a heating block located within the brew water tank. The heating block is preferably made of a thermally conductive material such as copper and will preferably have a body and thermally conductive vertical members extending vertically from the body within the brew water tank. The heating block may be plated with a non-corrosive, thermally conductive metal such as gold or tin. The heating block will be associated with a heat source which can be an electric heater. In use, the heating block will be substantially submerged in water in the brew water tank. When heat from the heat source is applied to the heating block, the vertical members will assure that temperature stratification is reduced within the water in the brew water tank. The vertical members act as equalizers between the hotter water at the top and the cold below, moving heat away from the top and cold away from the bottom.

Another aspect of the present invention is an espresso machine having a brew water tank, a brew head, and a pump associated with the brew water tank configured to pump water within the brew water tank to the brew head. Preferably, the pump head which consists of an input, and output, and an impeller mechanism, will be positioned within the brew water tank and in contact on at least one side with heated brew water. In addition, the brew water conduit connecting the pump to the brew head will be located substantially within the brew water tank. Thus, temperature loss in the brew water conduit or in the pump head will be minimized.

Another aspect of the present invention is an espresso machine having a brew water tank operatively associated with a first heat source as described above and a bayonet configured to secure a portafilter in fluid communication with the brew water tank. A second heat source may be operatively associated with the bayonet or portafilter. Thus, a reduction in the temperature of brew water as it passes through the ground coffee in the portafilter can be minimized.

Another aspect of the present invention is an espresso machine having a brew water tank and a brew head in fluid communication with the brew water tank where brew water is pumped from the brew water tank to the brew head through a brew water conduit. Preferably, a separate and distinct exhaust conduit may also be placed in fluid communication with the brew head, allowing the exhaustion of pressurized water from the brew head, after the preparation of a shot of espresso, entirely through a conduit which is separate from the clean water supply.

Another aspect of the present invention is an espresso machine as described above having a microprocessor and a temperature sensing device operatively associated with either the brew water tank or the bayonet, portafilter, or both. Feedback from the temperature sensing device can be interpreted by the microprocessor and used to precisely control the temperature of the water in the brew water tank or the temperature of the bayonet, portafilter, or both.

The espresso machine of the present invention may also have a pressure sensing device operatively associated with the brew head such that the pressure sensing device provides feedback to the microprocessor which controls the output of the pump to a select pressure. The espresso machine may also have a timer or the microprocessor may include timing codes or functionality which allow it to control pressure as a function of time facilitating an automatic ramped pre-infusion stage where pressure is gradually added to the ground coffee in the portafilter over a select period of time.

Another aspect of the present invention is a method of controlling an espresso machine which includes providing a heated water source, pumping heated water with a pump from the heated water source to a brew head including a bayonet and a portafilter, and heating the bayonet to a select temperature with a heat source which is independent of the heated water. This method also includes passing the heated water through the bayonet and portafilter.

The heated water of the heated water source may be heated by providing a brew water tank containing unheated brew water and providing a heating block operatively disposed within the brew water tank. The heating block will include a thermally conductive body and thermally conductive vertical members extending vertically from the body through a portion of the brew water. Heat may be applied to the brew water through the heating block and vertical members by applying heat from a heat source to the heating block.

The method of controlling an espresso machine may be automated by providing a microprocessor and a sensing device, such as a pressure sensing device or temperature sensing device, in association with the espresso machine and controlling temperature and pressure at various stages of the brew process with the microprocessor. The method may also include exhausting water from the brew head through an exhaust conduit which is separate from the brew water conduit.

### BRIEF DESCRIPTION OF THE DRAWINGS

FIG. 1 is a side cross sectional view of an espresso machine according to the present invention;

FIG. 2 is a front cross sectional view of an espresso machine according to the present invention; and

FIG. 3 is a schematic diagram of a control system in accordance with the present invention.

### DETAILED DESCRIPTION OF THE PREFERRED EMBODIMENT

Although the apparatus described herein is described and shown in the figures with reference to an espresso machine, it should be noted that the various temperature and pressure control aspects of the invention described herein are applicable to other types of brewed beverages machines. For example, the temperature, pressure, and brew time controls described below are applicable to single serving coffee making apparatus and single serving tea making apparatus.

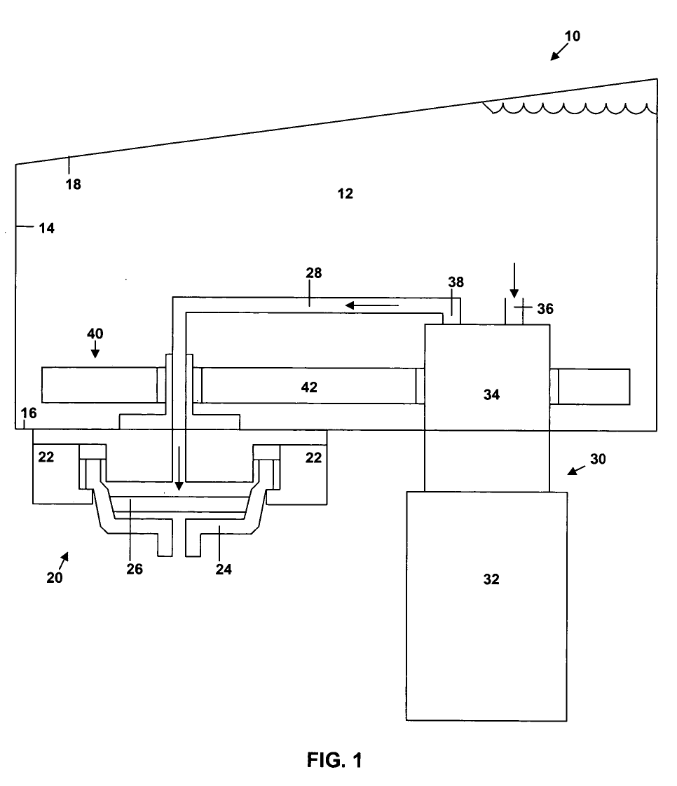

An espresso machine 10 in accordance with the present invention is shown in a side cross sectional view in FIG. 1. The espresso machine 10 has a brew water tank 12 which preferably has four sides 14 and a bottom 16 fabricated of stainless steel which provides adequate insulation and excellent resistance to corrosion. Corrosion can taint the flavor of espresso. Typically, the top 18 of the brew water tank 12 is fabricated from copper because of copper's excellent thermal transmission properties. The insulating properties of the bottom and sides will reduce the loss of heat from the relatively cool water lower in the tank, while the copper top transmits heat from the relatively hotter upper parts of the water. Preferably, the tank 12 or the top 18 is tilted such as to keep the water in contact with the copper tank top. All copper parts are preferably plated with gold, tin, or a similar non-corroding metal to prevent contamination of the brew water from copper corrosion products.

Attached to the forward bottom 16 of the brew water tank 12 is a brew head 20. The brew head 20 consists of a bayonet 22 which is typically a semicircular clamp device designed to receive a portafilter 24 in a releasable sealing engagement. The portafilter 24 will typically have a handle (not shown on FIG. 1) which allows easy removal of the portafilter 24 from the bayonet 22. The portafilter 24 will also have a mesh or screen filter basket (not shown on FIG. 1) into which the coffee is packed (tamped) prior to brewing.

The portafilter 24 holds a disc or puck of ground coffee 26 which is selected, ground, and tamped as is suitable for making high quality espresso. When engaged with the bayonet 22, the portafilter 24 will form a seal which allows the application of pressurized hot water from the brew water tank 12 to the coffee 26 for extraction.

Clean brew water is provided to the brew head 20 through a brew water conduit 28. Preferably, the brew water conduit 28 is situated substantially within the brew water tank 12 so that water temperature decrease within the brew water conduit 28 is minimized.

Also operatively associated with the brew water tank 12 is a pump 30. Typically, the pump 30 will consist of a pump motor 32 and a pump head 34. The pump head 34 will have an inlet 36 in fluid communication with the water in the brew water tank 12. Similarly, the pump head 34 will have an outlet 38 in fluid communication with the brew water conduit 28.

Inside the pump head 34 is an impeller mechanism designed to force pressurized water from the pump inlet 36 through the pump outlet 38. The impeller mechanism can be of any type known in the pump arts, however, a gear pump head has proven to be particularly suitable for use in the present invention.

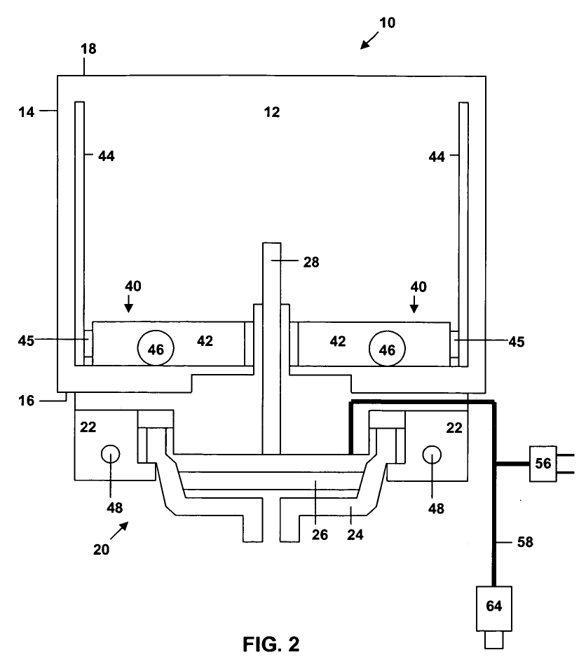

FIG. 2 is a front cross sectional view of an embodiment of the present invention showing many of the features illustrated in FIG. 1. As is best shown in FIG. 2, one or more heating blocks 40 are situated within the brew water tank 12. Each heating block 40 will preferably have a body 42 and one or more vertical members 44. The vertical members may or may not be in direct contact with the main heater block. The vertical members 44 may be separated from the body 42 by a spacer 45 which can be fabricated from a thermally transmissive material such as gold or tin plated copper, or from a thermal insulator such as Teflon®. Both the body 42 and vertical members 44 of the heating block 40 are preferably fabricated from a highly thermally conductive material such as copper. These copper members are also preferably plated with a non-corrosive plating such as gold or tin. FIG. 2 illustrates an implementation of the invention with two heating blocks 40. Alternatively, one block can be used with openings for access to the brew head 20 and pump head 34. Embodiments with any number of heating blocks are within the scope of the invention. Typically, the heating blocks 40 will be relatively massive, and thus form a heat reservoir helping to maintain a stable temperature within the brew water tank 12 and causing cold makeup water to rise rapidly to brew temperature. In use, the heating blocks 40 will be wholly or partially submerged in the brew water located in the brew water tank 12, and the brew water will be heated by direct conduction from the heating blocks 40 over all contact surfaces. The vertical orientation of the vertical members 44 with respect to the water within the brew water tank 12 will help assure that temperature stratification, which can compromise the consistency of brew water temperature, is minimized within the brew water tank 12.

Heat is applied to the heating blocks 40 from a heat source 46. Preferably, the heat source 46 is an electric cartridge heater situated within or in contact with the body 42 of a heating block 40. The heat source 46 could, however, be external to the heating block 40 with heat transferred to the heating block 40 through conventional heat exchanger apparatus.

As mentioned above, positioning the brew water conduit 28 and the pump head 34 within the brew water tank 12 serves to minimize any temperature loss as brew water is pumped from the brew water tank 12 to the brew head 20. The portafilter 24 may be independently heated. In one embodiment of the invention, the portafilter 24 is independently heated by contact with the bayonet 22 having an independent bayonet cartridge heaters 48 as shown in FIG. 2. Other external or internal heat sources may be suitable for heating the bayonet 22, such as replaceable cartridge heaters or external heaters connected to the bayonet 22 by conventional heat exchange apparatus. Alternatively, heat can be applied directly to the portafilter 24.

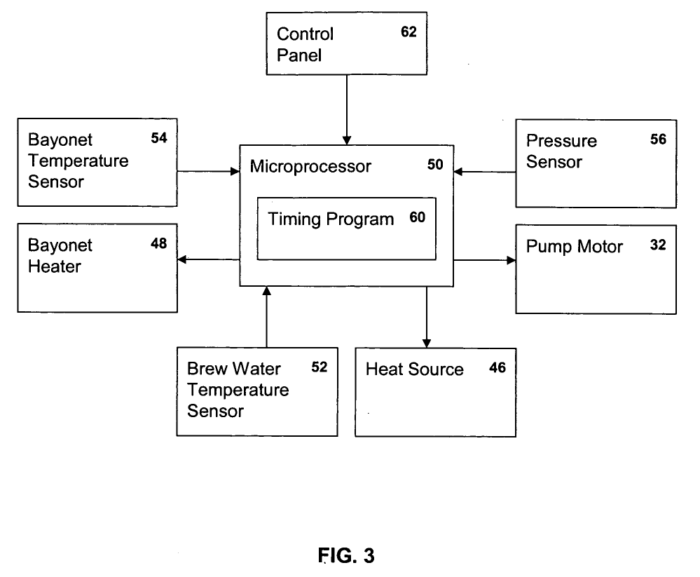

Preferably, the espresso machine 10 of the present invention will feature a temperature and pressure control mechanism. As shown schematically in FIG. 3, the functionality of the espresso machine 10 may be controlled by one or more internal or external microprocessor(s) 50. A microprocessor 50 can be a self-contained unit or a microprocessor 50 may be associated with a separate computing system communicating with the espresso machine 10. A brew water temperature sensor 52 may be operatively associated with the brew water tank 12. The brew water temperature sensor 52 may be a thermocouple, or other temperature sensing device immersed in the brew water, attached to a heating block 40, affixed to a side 14 or bottom 16 of the brew water tank 12, or otherwise situated to sense the temperature of the brew water. The brew water temperature sensor 52 will provide data concerning the temperature of the brew water to a microprocessor 50. In turn, the microprocessor 50 will provide feedback to the heat source 46, thus controlling the brew water temperature. Any control method or algorithm which is suitable for controlling a temperature may be implemented by the microprocessor 50. However, a PID control algorithm is typically used to control fluid process temperatures with feedback loops in the process industries, and is well suited for control of the heat source 46 by the microprocessor 50.

Similarly, a bayonet temperature sensor 54 may be operatively associated with the bayonet 22. The bayonet temperature sensor 54 can provide data to the microprocessor 50 which will then control the bayonet heater 48 using a PID control algorithm or other control method.

As discussed above, it is critical that pressurized brew water not be applied to the ground coffee 26 too rapidly. If pressurized water is applied too rapidly, the puck can break up, resulting in an unsatisfactory extraction. Thus, a ramped application of pressure during a pre-infusion period is necessary to assure the integrity of the puck during the extraction process. Typically, a ramped pre-infusion stage is ignored or accomplished manually with prior art espresso machines. An embodiment of the present invention features a pressure sensor 56 operatively associated with the brew head 20. The pressure sensor 56 can be any type of pressure sensor known in the process control arts. The pressure sensor 56 will typically be associated with the portafilter 24, the brew water conduit 28, or exhaust line 58. The pressure sensor 56 could also be associated with the pump head 34. The pressure sensor 56 may provide data to the microprocessor 50 which will use the data to provide feedback to the pump motor 32, assuring that the pump motor 32 operates at a level sufficient to achieve a satisfactory brew pressure throughout the extraction process. In addition, the microprocessor 50 will preferably have a timing program 60 or be associated with an external timer so that the microprocessor 50 may be used to selectively ramp the pump motor 32 and pumping rate, achieving full brew pressure over a select period of time. Thus, with the present invention, the pre-infusion step can be accurately automated.

Typically, the microprocessor 50 will receive inputs from a control panel 62 in addition to the inputs received from the various temperature and pressure sensors 52, 54, 56. The control panel 62 will have a user interface as is typically known in the computer or smart appliance arts which allows the user to set various parameters such as brew water temperature, bayonet 22 temperature, brew water pressure at the brew head 20, and pre-infusion ramp time.

The flavor and quality of espresso can easily be tainted by any number of foreign substances. For this reason, copper parts such as the top 18 of the brew water tank 12 or the heating blocks 40 must be plated or coated with a non-corrosive substance such as gold or tin plating. Equally important is assuring that an espresso is not contaminated with potentially rancid coffee leavings from a prior extraction.

All espresso machines must have an exhaust system associated with the brew head 20, allowing the release of remaining pressurized water after extraction. A typical prior art espresso machine often utilizes a three way valve in association with a brew water supply line which selectively allows the diversion of pressurized water to the drain. This type of system, however, can cause fresh brew water to first pass through a section of conduit 28 coated with coffee oils and extracts which may have become rancid. The espresso machine 10 of the present invention features a wholly separate exhaust line 58 associated with an exhaust valve 64. With this configuration, pressurized water which may be contaminated with residual coffee oils or solids can be exhausted from the system without risk of fouling the brew water conduit 28.

Another aspect of the present invention is a method of operating an espresso machine 10 such as that described herein. The method includes providing a heated water source such as the brew water tank 12. Heated water may be pumped with a pump 30 from the brew water tank 12 to a brew head 20 which includes a bayonet 22 and portafilter 24. The bayonet 22 or portafilter 24 may be heated to a select temperature with a supplemental second heat source which is independent of the heated water and any apparatus for maintaining the heat in the brew water tank 12. For example, the bayonet 22 or portafilter 24 may be heated with one or more independent bayonet cartridge heaters 48. In this manner, the temperature loss associated with pumping heated water through the bayonet 22 and portafilter 24 may be minimized.

The heated water in the brew water tank 12 may be heated by placing a heating block 40 having a body 42 and one or more vertical members 44 within the brew water tank. Heat may be conducted to water in the brew water tank 12 by applying heat from a heat source to the heating block 40. The heat source may be a cartridge heater 46.

Brew water temperature and brew water pressure may be controlled at various points in the system with a microprocessor 50 receiving input from one or more sensors. The sensors may include, but are not limited to, a bayonet temperature sensor 54 associated with the bayonet heater 48, a brew water temperature sensor 52 associated with the first heat source 46, and a pressure sensor 56 associated with the pump 30.

The method of operating an espresso machine 10 may also include exhausting water from the brew head 20 through an exhaust line 58 associated with an exhaust valve 64. Both the exhaust line 58 and the exhaust valve 64 may be maintained wholly separate from the brew water conduit 28.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims.

What is claimed is:

1. An espresso machine comprising:
a brew water tank;
a thermally conductive heating block operatively disposed within the brew water tank; and
a first heat source operatively associated with the heating block.

2. The espresso machine of claim 1 further comprising at least one thermally conductive vertical member extending vertically from and operatively associated with the heating block.

3. The espresso machine of claim 1 further comprising:
a microprocessor and
a first temperature sensing device operatively associated with the brew water tank and the microprocessor such that the microprocessor may control the first heat source in response to input from the temperature sensing device.

4. The espresso machine of claim 1 further comprising:
a pump operatively associated with the brew water tank to pump water within the brew water tank to a brew head; and
a pump head operatively associated with the pump, the pump head comprising an input, an output and an impeller mechanism wherein the input, the output and the impeller mechanism are positioned within the brew water tank.

5. The espresso machine of claim 4 further comprising:
a microprocessor; and
a pressure sensing device operatively associated with the brew head and the microprocessor such that the microprocessor may control the pump in response to input from the pressure sensing device.

6. The espresso machine of claim 5 further compromising a timer operatively associated with the microprocessor such that the microprocessor may control the flow of water from the brew water tank to the brew head as a function of time.

7. The espresso machine of claim 1 further comprising:
a bayonet releasably securing a portafilter; and
a second heat source operatively associated with one of the bayonet and the portafilter.

8. The espresso machine of claim 7 further comprising:
a microprocessor; and
a second temperature sensing device operatively associated with one of the bayonet and the portafilter and the microprocessor such that the microprocessor may control the second heat source in response to input from the second temperature sensing device.

9. The espresso machine of claim 1 further comprising:
a brew head in fluid communication with the brew water tank through a brew water conduit; and
an exhaust line in fluid communication with the brew head wherein the exhaust line is distinct from the brew water conduit.

10. An espresso machine comprising:
a brew water tank;
a heating block operatively disposed within the brew water tank;
a first heat source operatively associated with the heating block;
at least one thermally conductive vertical member extending vertically from and operatively associated with the heating block;
a brew head in fluid communication with the brew water tank through a brew water conduit;
a pump operatively associated with the brew water tank to pump water within the brew water tank to a brew head;
a bayonet releasably securing a portafilter in fluid communication with the brew water tank;
a second heat source operatively associated with one of the bayonet and the portafilter; and
an exhaust conduit in fluid communication with the brew head wherein the exhaust conduit is distinct from the brew water conduit.

11. The espresso machine of claim 10 further comprising a pump head operatively associated with the pump, the pump head comprising an input, an output, and an impeller mechanism, wherein the input, the output, and the impeller mechanism are positioned within the brew water tank.

12. The espresso machine of claim 10 further comprising:
a sensor operatively associated with one of the brew water tank, the bayonet and the portafilter configured to sense a water temperature; and
a microprocessor configured to receive input from the sensor.

13. The espresso machine of claim 12 further comprising a sensor operatively associated with one of the brew water tank, the bayonet, and the portafilter, configured to sense a water pressure.

14. The espresso machine of claim 13 further comprising a timer operatively associated with the microprocessor such that the microprocessor may control the flow of water from the brew water tank to the brew head as a function of time.

15. A method of operating an espresso machine comprising:
providing a heated water source;
pumping heated water with a pump from the heated water source to a brew head comprising a bayonet and a portafilter;
heating the bayonet to a select temperature with a bayonet heat source which is independent of the heated water; and
passing the heated water through the bayonet and portafilter.

16. The method of claim 15 wherein the heated water of the heated water source is heated by:
providing a brew water tank containing brew water;
providing a heating block operatively disposed within the brew water tank, the heating block having a thermally conductive body and thermally conductive vertical members extending vertically from the body through a portion of the brew water; and
applying heat from a tank heat source to the heating block.

17. The method of claim 16 further comprising controlling the temperature of the heated water in the heated water source with a microprocessor receiving input from a temperature sensor, and providing output to at least one of the bayonet heat source and the tank heat source.

18. The method of claim 15 further comprising:
providing a pressure sensing device operatively associated with the brew head and a microprocessor; and
controlling the pump output pressure with the microprocessor in response to input from the pressure sensing device.

19. The method of claim 18 further comprising controlling the pump output pressure as a function of time in response to input to the microprocessor from a timer.

20. The method of claim 15 further comprising exhausting water from the brew head through an exhaust conduit which is separate from the brew water conduit.
